(19) United States
(12) Patent Application Publication
(10) Pub. No.: US 2023/0366157 A1
(43) Pub. Date: Nov. 16, 2023

(54) TISSUE PAPER PRODUCTS, ROLLS AND STACKS OF TISSUE PAPER PRODUCTS, AND MANUFACTURING METHODS

(71) Applicant: Essity Hygiene and Health Aktiebolag, Goteborg (SE)

(72) Inventor: Sébastien Jeannot, Kunheim (FR)

(21) Appl. No.: 18/013,667

(22) PCT Filed: Jul. 3, 2020
(86) PCT No.: PCT/IB2020/000588

§ 371 Date: Dec. 29, 2022

(51) Int. Cl. D21H 27/40; D21H 27/00; B31F 1/07

(52) U.S. Cl. CPC D21H 27/40; D21H 27/004; B31F 1/07; B31F 2201/0725; B31F 2201/0774; B31F 2201/0787; B31F 2201/0764

(57) ABSTRACT

Disclosed is a tissue paper product including at least three plies with a top ply and bottom ply as outermost plies, and an inner ply between the top and bottom plies, a basis weight of the tissue paper product being 30-150. The top ply being embossed with at least two types of embossments including first embossments with a first height and second embossments with a second height, the first height being larger than the second height, and the bottom ply is embossed, the inner ply and the top ply being bonded with the bottom ply at tips of the first embossments with an adhesive, such as a lamination glue, or the inner ply, the top ply, and the bottom ply are ply-bonded with mechanical bonding, at least one of the top ply and the bottom ply being embossed by a heated embossing roll.

### CROSS REFERENCE TO RELATED APPLICATION

This application is a National Stage application of PCT/162020/000588, filed Jul. 3, 2020, which is incorporated by reference in its entirety herein.

### TECHNICAL FIELD

The present disclosure relates to a tissue paper product, such as household towel or toilet paper, comprising a least three plies, wherein the outermost plies of the tissue paper product are embossed. The disclosure also relates to a roll of such a tissue paper product and to a stack of such a tissue paper product. Moreover, the disclosure relates to methods of manufacturing the same.

### TECHNICAL BACKGROUND

In the following, a “tissue paper product” relates to an absorbent paper based on cellulose wadding. The latter is also referred to as a tissue paper base-sheet in this field of technology.

Fibres contained in a tissue paper product are mainly cellulosic fibres, such as pulp fibres from chemical pulp (e.g. Kraft or sulphite), mechanical pulp (e.g. ground wood), thermo-mechanical pulp, chemo-mechanical pulp and/or chemo-thermo-mechanical pulp (CTMP). Pulps derived from both deciduous (hardwood) and coniferous (softwood) can be used. Fibres may also come from non-wood plants, e.g., cereal, bamboo, jute, and sisal. The fibres or a portion of the fibres may be recycled fibres, which may belong to any or all of the above categories. The fibres can be treated with additives, e.g. fillers, softeners, such as, but not limited to, quaternary ammonium compounds and binders, conventional dry-strength agents, temporary wet strength agents or wet-strength agents, in order to facilitate the original paper making or to adjust the properties thereof. The tissue paper product may also contain other types of fibres, e.g., regenerated cellulosic fibres or synthetic fibres for enhancing, for instance, strength, absorption, smoothness or softness of the tissue paper product.

Tissue paper products may be used for personal and household use as well as for commercial and industrial use. They may be adapted to absorb fluids, remove dust, and for other cleaning purposes. If tissue paper is to be made out of pulp, the process essentially comprises a forming step that includes a headbox- and a forming wire section, and a drying section, either through air drying or conventional drying on a Yankee cylinder. The production process may also include a crepe and, finally, typically a monitoring and winding step.

Several plies may be combined together by a combining operation of a chemical nature (e.g., by adhesive bonding), or of a mechanical nature (e.g., by knurling or so-called edge-embossing), or a combination of both.

Further, the processing to finished tissue product may involve, e.g., longitudinal cut, folding, cross cut, etc. Moreover, individual tissue products may be positioned and brought together to form stacks, which may be individually packaged. Such processing steps may also include application of substances like scents, lotions, softeners or other chemical additives.

When several plies are combined together using adhesive bonding, a film of adhesive is deposited over some or all of the surface of at least one of the plies, then the adhesive-treated surface is placed in contact with the surface of at least one other ply.

When several plies are combined together using mechanical bonding, the plies may be combined by knurling, by compression, by edge-embossing, union embossing and/or ultrasonic.

Mechanical and adhesive bonding may also be combined to combine several plies

The processing step from the base tissue to a finished tissue paper product occurs in processing machines (converting machines) which include operations such as unwinding the base tissue, calendaring of the tissue, laminating, printing or embossing together to form a multi-ply product.

Embossing can be used to change the shape of a ply from flat to shaped, so that there are areas that are raised and/or recessed from the rest of the surface. It therefore constitutes a deformation of the previously flat sheet, and results in a ply having a particular relief. The thickness of the ply or of the multiple plies is increased after embossing compared with its initial thickness.

An embossing process is carried out between an embossing roll and a counter roll. The embossing roll can have protrusions or depressions on its circumferential surface leading to embossed protrusions/depressions in the paper web. Counter rolls may be softer than the corresponding embossing roll and may consist of rubber, such as natural rubber, or plastic materials, paper or steel. If the counter roll is made of a softer material like rubber, a contact area/nip can be formed between the embossing roll (e.g., steel roll) and the counter roll by the deformation of the softer roll.

By embossing, a pattern can be applied to a tissue paper fulfilling a decorative and/or functional purpose. A functional purpose may be to improve the properties of the hygiene paper product, that is, the embossment may improve the product thickness, absorbency, bulk, softness, etc. A functional purpose may also be to provide a joint to another ply in a multi-ply product.

Another type of embossment is referred to herein as a “pre-embossment”. A pre-embossment could preferably be applied to a web or ply prior to its joining to the other plies of a multi-ply tissue product.

Such pre-embossment may be made for a functional purpose e.g. as laid out in the above to increase the thickness of the ply, the absorbency, bulk and/or softness.

“Micro-embossment” is used herein for an embossment pattern with a dense configuration. Typically, the micro-embossment may comprise dots in the range 25 to 100 dots per cm2, preferably 35 to 80 dots per cm2. A micro-embossment may advantageously be a pre-embossment. The micro-embossed dots may have different relatively simple surface shapes such as circles, ovals, squares, rectangles or diamonds.

Although the multi-ply tissue paper products and methods for production thereof proposed in the past may be very useful in many applications, there is still a need for improvements. Such improvements would be desirable particularly with respect to the thickness, the strength, the softness, the bulkiness, and/or the absorption capacity of the multi-ply tissue products.

There is, hence, a desire for an improved tissue paper product with at an improvement in at least one of the above-mentioned properties, and for a manufacturing method for such a product.

### SUMMARY

Aspects of the above-mentioned object are achieved by a tissue paper product in accordance with the present disclosure.

One aspect of the present disclosure relates to a tissue paper product, such as toilet paper or household towel. The tissue paper product comprises at least three plies including a top ply, a bottom ply, and an inner ply located between the top ply and the bottom ply. The top ply and the bottom ply are outermost plies of the tissue paper product. A basis weight of the tissue paper product is in a range of from 30 to 150, optionally 30 to 100 g/m², or 35 to 80 g/m², or 40 to 65 g/m². The top ply has been embossed and comprises at least two types of embossments including first embossments with a first height and second embossments with a second height, the first height being larger than the second height. The inner ply has not been embossed. Moreover, the bottom ply has been embossed. The top ply, the inner ply, and the bottom ply are ply-bonded with an adhesive, such as a lamination glue, and/or water and/or mechanical bonding, such as edge embossing. In other words, only ply-bonding with adhesive or only ply-bonding using water, or only ply-bonding using mechanical bonding may be used, or two or three of these methods may be combined.

When using adhesive, the adhesive may, e.g., be provided to parts of a side of the inner ply facing the tips of the (e.g., first and/or second) embossments of the first ply, and/or adhesive may, e.g., be provided to tips of (e.g., the first and/or second) embossments of the first ply.

A bonding pressure applied to plies to be ply-bonded using water may be set higher than for embodiments in which plies are ply-bonding using an adhesive such as lamination glue.

Moreover, at least one of the top ply and the bottom ply has been embossed by a heated embossing roll.

The statement that the inner ply has not been embossed does not necessarily mean that the inner ply is flat, as some undulations may, e.g., be imparted from neighboring plies due to or after ply-bonding, and the inner ply may, e.g., also be creped, etc. However, the inner ply has not been (pre-embossed by an embossing roll prior to final ply-bonding taking place. This is what is meant by not having been embossed (no pre-embossing prior to the final ply-bonding).

Whenever reference is made to the “basis weight” in this text, reference is made to the basis weight (grammage) as determined by a test method following the principles set forth in standard EN ISO 12625-6:2016 for determining the basis weight. Test pieces of 50 cm² are punched from the sample sheet. Test pieces are chosen randomly from the entire sample and should be free of folds, wrinkles and any other deviating distortions. The pieces are conditioned at 23° C., 50% RH (Relative Humidity) for at least 2 hours. A pile of 20 pieces is weighed on a calibrated balance. The basis weight (grammage) is the weighed mass divided by the total area 1000 cm² (20×50 cm²) and recorded as mean value with standard deviations.

The embossing of at least one of the outermost plies with a heated embossing roll may be advantageous as the embossments may have a better shape memory, i.e., they may be more resilient against shape deformation when the tissue paper product is wet. That is, the embossments being less affected when the ply is wet. This means that the tissue paper product may have a better absorption capacity than a comparable tissue paper product which does not comprise at least one ply that was embossed using a heated embossing roll. Moreover, as compared to a product without a ply that was embossed using a heated embossing roll with a certain thickness and strength (tensile strength), a higher thickness may be reached while retaining the same tensile strength. In other words, the tissue paper product in accordance with the present disclosure has high thickness and good absorption properties, as well as a high tensile strength. In particular, with the same embossing load during a manufacturing process, a higher thickness of the tissue product may be reached.

Whenever reference is made to the “absorption capacity” in this text, reference is made to an absorption capacity measured as follows. The measurements are carried out using the basket immersion method. A test sample with a defined width and total mass is placed in a cylindrical basket which is dropped from a defined height over a water surface with deionized water in accordance with ISO 14487 (conductivity≤0.25 mS/m at 25 C). The time is measured between when the basket is dropped until the test sample is fully wet. The average time recorded for a number of samples is the equated to the water absorption time. The amount of absorbed water is determined from the dry and wet weight of the test sample. Previous to the measurement, the test samples are to be conditioned a sufficient time under 23° C. and 50% relative humidity (see ISO 187-standard atmosphere for conditioning and testing tissue). The resulting water absorption capacity is reported in grams water per gram test piece to the nearest 0.1 g/g. The method is carried out in accordance with ISO 12625-8:2011 (water-absorption time and water-absorption capacity, basket-immersion test method).

Whenever reference is made to the “thickness” in this text, reference is made to the thickness as obtained in accordance with European standard EN 12625-3 using the Frank Thickness Gauge equipment (Model 16502) or the like. The tissue paper sheet to be measured is cut into pieces of minimum 80mm in any direction and the pieces are conditioned at 23° C., 50% RH (Relative Humidity) for at least 2 hours. During measurement a sample piece is placed between a fixed bottom plate and a pressure foot. The pressure foot is then lowered at a speed of 2.0 mm/s. The thickness value for the sheet is then read after the pressure value is stabilized. The diameter of the pressure foot is 35.7 mm. The lower plate dimension is minimum 20% bigger. The pressure applied is 2.0 kPa during the measurement.

Whenever reference is made to a “tensile strength” in this text, the tensile strengths in question can be measured and compared as dry tensile strengths following the standard EN ISO 12625-4:2005 or as wet tensile strengths following the standard ISO 12625-5:2005.

The dry strength is determined according to EN ISO 12625-4: 2005, Tissue Paper and Tissue Products, Part 4: Determination of width-related breaking strength, elongation at break and tensile energy absorption. For exemplary purposes, the tensile tester used for the measurement featured two clamps of 50 mm width. Each clamp can grip the test piece firmly, but without damage, along a straight line across the full width of the test piece (the clamping line). The distance between the clamping lines was set at 100 mm. For special tests, the distance is reduced if the available length of the sample is lower than 100 mm (e.g., toilet tissue in cross direction). The tissue paper product to be measured, i.e., two sheets of a single-ply or multi-ply product, was cut into test pieces of 50 mm wide with parallel edges. Each sheet was cut into two different types of test pieces by cutting in the machine direction and in the cross direction. The obtained test pieces were then conditioned in an atmosphere of 23° C., 50% RH (Relative Humidity) for at least 4 hours. The test piece to be measured was placed between the clamps without any strain, and such that any observable slack is eliminated. At the beginning, a pre-tensile force of 25 cN is applied (zero of stretch) then the elongation rate between the clamps was kept constant at 5 cm/min. The maximum tensile force required to break the test piece was obtained. The measurement was repeated with six test pieces and the values obtained were averaged. The dry tensile strength was calculated by means of the following formula:

Mean dry tensile strength [N/m]=(mean maximum tensile force [N]/initial width of the test piece [mm])×10<3.

The wet strength was determined according to EN ISO 12625-5 Tissue Paper and Tissue Products, Part 5: determination of width-related wet load at break, 2005. (optionally the following description which follows the principles of the DIN NORM). For exemplary purposes, when experimentally verifying the wet strength of a product, the tensile test was accordingly performed by means of an electronic tensile test apparatus (Model 1122, Instron Corp., Canton, Mass., USA) with a constant rate of elongation of 50 mm/min using a Finch device. To prepare the test strips, 6 samples each having a length of 150 mm and a width of 50 mm were cut from the raw tissue (single ply) prepared in such a manner that the longitudinal direction of the test strips coincided with the machine direction (MD) or cross-direction (CD). The free clamping length when using the Finch clamp was about 50 mm. The test strip was secured with both ends in a clamp of the test apparatus. The other end (loop) formed in this way was placed around a pin and treated at 23° C. with distilled water until complete saturation. The depth of immersion of the loop formed by the test strip is at least 20 mm. The soaking duration (immersion time) is 15 s, the rate of elongation is set to a constant (50±2) mm/min, the measurement of the breaking strength is performed on the sample immersed in distilled water. Six test strips at a time were measured, the result being indicated as an arithmetic mean. To ensure that the wet strength of the samples has fully developed, which is particularly necessary in the case of samples in which additional wet-strength agents were used to boost wet strength, e.g., by their addition in the mass, the samples to be tested were always artificially aged before conducting the tensile test. Aging was effected by heating the samples in an air-circulating drying cabinet to (80±1) ° C. for a period of 30 min. Six test strips at a time were measured, the result being indicated as an arithmetic mean.

The tissue paper product may in particular be a toilet paper. However, also other tissue paper products are covered, for example, hand towels, napkins, facial tissues, toilet paper, etc.

A moisture content of a mother reel used to supply plies for manufacturing tissue paper products in accordance with the present disclosure may be in a range of 3% to 15%, optionally 3% to 10%, or optionally 4% to 7%.

If ply-bonding with an adhesive is used, the adhesive may, e.g., be a polyvinyl alcohol and/or a methyl cellulose based adhesives. An adhesive may, for example, be applied based on spraying equipment.

The top ply comprises two types of embossments and may have been processed using “double height embossing” whereby one or several rolls with embossing protrusions having different heights were used. Double height embossing may not only serve to provide bulk to the fibrous product but also to provide an improved optical appearance to the product. The optical appearance can be improved by combining embossing and coloring steps. Another reason for embossing is to generate higher absorbency or improved perceived softness.

Tissue paper products in particular for use as hygiene or wiping products primarily include all kinds of dry-creped tissue paper, wet-creped paper, TAD-paper (Through Air Drying), tissue paper based on structured technologies such as ATMOS®, NTT, UCTAD and cellulose or pulp-wadding, or combinations, laminates or mixtures thereof. Typical properties of these hygiene and wiping products include the ability to absorb tensile stress energy, their drapability, good textile-like flexibility, properties which are frequently referred to as bulk softness, a high surface softness and a high specific volume with a perceptible thickness. A liquid absorbency as high as possible and, depending on the application, a suitable wet and dry strength as well as an appealable visual appearance of the outer product's surfaces are desired. These properties, among others, allow these hygiene and wiping products to be used, for example, as cleaning wipes such as windscreen cleaning wipes, industrial wipes, kitchen paper or the like; as sanitary products such as, for example, bathroom tissue, handkerchiefs, household towels, towels and the like; as cosmetic wipes such as for example facials and as serviettes or napkins, etc. Furthermore, the hygiene and wiping products can be dry, moist, wet, printed or pre-treated in any manner. In addition, the hygiene and wiping products may be folded, interleaved or individually placed, stacked or rolled, connected or not, in any suitable manner.

According to some embodiments, the edge embossing used for the ply-bonding may have been performed with a bonding pressure in the range of 40 to 50 N/mm² This may provide a reliable ply-bonding without compromising the embossments and/or the thickness of the product, and it may be a particularly beneficial combination of ply-bonding with the manufacturing step relying on the heated embossing roll. Edge embossing may sometimes also be referred to as knurling.

According to some embodiments, at least one of the plies of the tissue paper product, optionally all of the plies of the tissue paper product, are made of Conventional Wet Press (CWP) paper. Producing a ply from paper-making fibers according to “Conventional Wet Paper” (CWP) processing may, e.g., rely on the manufacturing of “Dry Creped Tissue” or “Wet Crepe Tissue” and is to be distinguished from a “Process for Structured Tissue” such as the Through Air Drying (TAD) manufacturing method, the manufacture of un-creped through- air dried (UCTAD) tissue, or alternative manufacturing methods, e.g. the Advanced Tissue Molding System (ATMOS) of the company Voith, or Energy Efficient Technologically

Advanced Drying eTAD of the company Georgia Pacific, or Structured Tissue Technology SST of the company Metso Paper. Hybrid processes like NTT (New Textured Tissue of the company Metso Paper), which are alternations of the conventional processes, can be used.

According to some embodiments, the basis weight of the tissue paper product is in a range of 30 to 150 g/m², optionally 30 to 100 g/m², or 35 to 80 g/m², or 40 to 65 g/m². These ranges may, to in increasing extent for the narrower ranges specified, provide good combinations of thickness, (tensile) strength, and absorption capacities. The basis weight refers to the mass per unit area or gram weight.

According to some embodiments, the tissue paper product comprises a number of plies between three and six. Products with a total number of plies in these ranges may provide the best thickness, (tensile) strength, and absorption properties for purposes of household towels, hand towels, napkins, facial tissue, etc., while being cost-efficient.

Some embodiments of the tissue paper product comprise exactly three plies. By comprising exactly three plies, it is meant that they do not comprise a fourth or further plies, but that the number of plies is limited to three. Alternatively, it can be stated that the tissue paper product consists of three plies. However, this is not intended to exclude the presence of other components (other than plies), such as, e.g., an adhesive or some other additive (color on a decorative embossment, etc.). The tissue paper product may comprise further materials (such as, e.g., adhesive some additive, etc. For example, a printing may be added onto the tissue paper product before or after ply bonding. Another example is that chemical substances such as lotions and/or softeners may be applied. If the tissue paper product consists of a roll of sheets, for example, with perforation lines separating the sheets, then the tissue paper of the roll is still to be considered to comprise three plies (i.e., the respective plies of neighboring sheets are to be considered the same plies).

Some embodiments of the tissue paper product comprise exactly four plies. The four plies can be referred to as the top ply, the bottom ply, the inner ply, and an another ply. By comprising exactly four plies, it is meant that they do not comprise a fifth or further plies, but that the number of plies is limited to four. The tissue paper product may comprise further materials (such as, e.g., adhesive some additive, etc. Alternatively, it can be stated that the tissue paper product consists of four plies. However, this is not intended to exclude the presence of other components (other than plies), such as an adhesive or some other additive (color on a decorative embossment, etc.). If the tissue paper product consists of a roll of sheets, for example, with perforation lines separating the sheets, then the tissue paper of the roll is still to be considered to comprise four plies (i.e., the plies of neighboring sheets are to be considered the same plies).

The another ply and the top ply may have been embossed together (i.e., they may constitute a double-ply with embossments). Thereby, the top ply may first have been pre-embossed, and the top ply and the another ply share subsequently imparted embossments, or all embossments (e.g., first and second embossments), may have been formed together on the top ply and the another ply. Alternatively, the another ply and the bottom ply may have been embossed together. Another alternative is that the another ply and the inner ply may be combined with the top ply (all three plies may share at least one of the embossments or all types of embossments imparted to the top ply). The respective double- ply or triple ply may be ply-bonded with the bottom ply at tips of the first embossments with an adhesive, such as lamination glue.

According to some embodiments, both the inner ply and the another ply may be unembossed, in the sense of not having been pre-embossed prior to the final ply-bonding having been carried out.

Some embodiments of the tissue paper product comprise exactly five plies or exactly six plies. By comprising exactly five or six plies, it is meant that they do not comprise a respective further (sixth or seventh) ply, but that the number of plies is limited to five or six. The tissue paper product may comprise further materials (such as, e.g., adhesive some additive, etc. Alternatively, it can be stated that the tissue paper product consists of five or six plies. However, this is not intended to exclude the presence of other components (other than plies), such as an adhesive or some other additive (color on a decorative embossment, etc.). If the tissue paper product consists of a roll of sheets, for example, with perforation lines separating the sheets, then the tissue paper of the roll is still to be considered to comprise five or six plies (i.e., the plies of neighboring sheets are to be considered the same plies).

Embodiments of the tissue paper product with five plies may have a structure in which the following components are ply-bonded to form the product (starting from the outside end which is faced by the top ply comprising two types of embossments): a double-ply (including the top ply and a further ply sharing at least one of the embossments with the top ply), a further double-ply, and a single ply (the bottom ply); a double-ply (including the top ply and a further ply sharing at least one of the embossments with the top ply), a single ply, and a further double-ply (including the bottom ply and a further ply sharing at least one of the embossments with the top ply); a single ply, and two double plies; a triple ply and two single plies; a single ply, a further single ply, and a triple ply; etc.

Embodiments of the tissue paper product with six plies may have a structure in which the following is ply-bonded (starting from the outside end which is faced by the top ply comprising two types of embossments): three double-plies; a triple-ply, a single ply, and a double-ply; a triple-ply, a double-ply; and a single ply; a double-ply, a single ply, and a triple-ply; a double-ply, a triple-ply, and a single ply; a single ply, a double-ply, and a triple-ply; a single ply, a triple-ply, and a double-ply; a quadruple-ply, a single ply, and a further single ply; a single ply, a further single ply, and a quadruple-ply; etc.

According to some embodiments, the top ply includes exactly two types of embossments, being decorative embossments with an embossing height in a range of 0.2 mm to 2.0 mm, optionally 0.8 mm to 1.4 mm, and micro-embossments with an embossing height in a range of 0.1 mm to 1.2 mm. These embossments may be referred to as micro-embossments. The ranges may, to an increasing degree for the narrower ranges, be good choices for promoting a high thickness, combined with good tensile strength and good absorption capacity of the product, especially in view of the presence of at least one ply that was embossed using a heated embossing roll. In addition or alternative thereto, decorative embossments may cover between 1% and 20% of a total surface of the tissue paper product, optionally between 2% and 10%, or between 3% and 6%, wherein the increasingly narrower ranges may be increasingly desirable in terms of balancing the desire to have decorative embossments while not compromising any of the advantageous properties relating to absorption, thickness, and/or tensile strength.

The tissue paper product may comprise at least one region within which a density of the micro-embossments is, in the area of this region where the tissue paper product does not comprise the decorative embossments, in a range of 25 to 120 dots/cm², optionally 40 to 100 dots/cm², or 50 to 80 dots/cm². According to some embodiments, the density of the micro-embossments is, in the area of the entire tissue paper product, where the tissue paper product does not comprise the decorative embossments, in a range of 25 to 120 dots/cm², optionally 40 to 100 dots/cm², or 50 to 80 dots/cm². These densities may, to an increasing degree for narrower ranges, promote high strength and good absorption properties of the respective tissue paper product.

According to embodiments, an embossing density may be measured, e.g., using 3D tomography (for example, using Alicona Infinite Focus SL with the software IF-MeasureSuite Version 5.1). Alicona Infinite Focus SL with the software IF-MeasureSuite Version 5.1 may also be used to measure a surface area that has been embossed and/or an embossment height. The embossment height may be defined as a distance from a bottom of the ply to a top of the ply in sectional view.

The bottom ply may include exactly one or two types of embossments, wherein the density of the total number of embossments of the bottom ply is in the range of from 25 to 120 dots/cm², optionally 40 to 100 dots/cm², or 50 to 80 dots/cm². These densities may, to an increasing degree for narrower ranges, promote high tensile strength and good absorption capacities of the respective tissue paper product.

According to some embodiments, the top ply may include one or two types of embossments, being decorative embossments with an embossing height in a range of 0.2 mm to 2.0 mm, optionally 0.8 mm to 1.4 mm, and/or micro-embossments with an embossing height in a range of 0.1 mm to 1.2 mm. The decorative embossments may be provided with a density of 15 dots/cm² or less, optionally 10 dots/cm² or less.

According to some embodiments, the bottom ply may include one or two types of embossments, being decorative embossments with an embossing height in a range of 0.2 mm to 2.0 mm, optionally 0.8 mm to 1.4 mm, and/or micro-embossments with an embossing height in a range of 0.1 mm to 1.2 mm. The decorative embossments may be provided with a density of 15 dots/cm² or less, optionally 10 dots/cm² or less.

Micro-embossments and/or decorative embossments may be in the form of lines or dots or other shapes. In the case that the decorative embossments are dot-shaped, the density may be lower than 10 embossments/cm² for the decorative embossments.

According to some embodiments, the inner ply and the top ply are associated (ply-bonded) with the bottom ply by the adhesive applied only in an area comprising, optionally consisting of, the tips of the first embossments. This may be the case at at least 95%, 98%, or even at least at 99% of the tips of the first embossments.

According to some embodiments, the inner ply is a creped ply having a basis weight in the range of 13 to 30 g/m², optionally 16 to 28 g/m², or 18 to 24 g/m², wherein the creped ply comprises creping lines extending along a first direction and parallel ribs and valleys extending along a second direction.

An angle between the first direction and the second direction may be in a range of 80° to 100° (for some embodiments it is in the range between 85° and) 90°).

The ribs and valleys may provide an average core roughness Rk in the range of 10 to 300 μm. A number of peaks may be in the range of 4 to 12 per cm as measured in the first direction.

When the tissue paper comprises a creped ply as well as a ply that has been embossed by a heated embossing roll, the thickness of the tissue paper product may be particularly large. Moreover, the product may have particularly good strength and absorption properties, especially when compared with conventional products with a similar thickness.

Moreover, embodiments of the tissue paper product comprise a creped ply which was embossed using a heated embossing roll.

This disclosure also relates to a roll of tissue paper product made of a spirally wound continuous web of the tissue paper product in accordance with any one or several of the above-described embodiments. The tissue paper product has a first end and a second end. The web of tissue paper product is wound such as to define an axially extending inner hole centrally positioned relative to the roll and such that the first end is located on the outer side of the roll and the second end is located at the inner hole.

According to some embodiments, the tissue paper product of the roll is provided with perforations for tearing of individual sheets.

A diameter of the roll may be in a range of 85 to 200 mm (including the boundaries). Such a roll is particularly suitable for household towels.

This disclosure also relates to a stack of unfolded sheets or a stack of folded sheets of the tissue paper product in accordance with any one or several of the above-described embodiments. In the case of some embodiments, the folded sheets may be separate individual folded sheets, or individual separate interfolded sheets. Alternatively, continuous sheets (with or without perforations for separating sheets) may be folded to form the stack. Optionally, the folded sheets may be multi-interfolded.

According to some embodiments, the tissue paper product of the stack is provided with perforations for tearing of individual sheets.

This disclosure also relates to a method of manufacturing a tissue paper product, such as toilet paper or household towel, comprising at least three plies. The method may be used to manufacture a tissue paper product in accordance with any one or several of the above-described embodiments of tissue paper product. Every one of the features of an embodiment of the tissue paper product translates into a feature of an embodiment of the method, and vice versa.

An embodiment of a method in accordance with the present disclosure comprises the steps of:
feeding at least three plies, including a first ply, a second ply, and a third ply, with a basis weight in the range of 13 to 30 g/m², optionally 16 to 28 g/m², or 18 to 24 g/m², respectively;
embossing the first ply on a first embossing cylinder with embossing protrusions with a first height h1 to form first embossments on the first ply,
embossing the first ply on a second embossing cylinder with second embossing protrusions with a second height h2, the first height h1 being larger than the second height h2, wherein the embossing on the second embossing cylinder is carried out before or after the embossing on the first embossing cylinder;
embossing the second ply on a third embossing cylinder with embossing protrusions with a third height h3;
ply-bonding the first ply, the second ply, and the third ply, and optionally further plies, such that the first ply and the second ply are outermost plies and the third ply is an inner ply, using an adhesive, such as a lamination glue, and/or using water, and/or using mechanical bonding, such as edge embossing;

wherein the inner ply is not embossed, and

wherein at least one of the first embossing cylinder, the second embossing cylinder, and the third embossing cylinder is a heatable roll.

When performing the method, the heatable roll is heated, and the method allows producing a tissue paper product which may have the respective advantages discussed above.

When using adhesive, the adhesive may, e.g., be provided to parts of a side of the inner ply facing the tips of the (e.g., first and/or second) embossments of the first ply, and/or adhesive may, e.g., be provided to tips of (e.g., the first and/or second) embossments of the first ply.

The step of ply-bonding using an adhesive is not limited to applying the adhesive to a particular ply, but constitutes a limitation to where the plies are bonded together by virtue of the ply-bonding. The adhesive can be applied to different plies to achieve ply-bonding of the plies such that the plies are adhere to one another at least at tips of first embossments. That is, the disclosure encompasses embodiments where adhesive is present at tips of first embossments, irrespective of where the adhesive was applied to during the manufacturing process. However, this disclosure also encompasses particular embodiments of the method, involving the application of adhesive of tips of the first embossments (e.g., of the top ply) on the side facing a ply to be ply- bonded therewith.

With “edge embossing”, reference is made to a technique of mechanically bonding plies on the edges. This may be done with wheels with two lines of side embossing and a flat counter-cylinder, and the ply-bonding is effected by exerting mechanical pressure.

A bonding pressure applied to plies to be ply-bonded using water may be set higher than for embodiments in which plies are ply-bonding using an adhesive such as lamination glue.

Base tissue paper may be produced by placing fibres in an oriented or random manner, on one or between two endless continuously rotating wires or felts of a paper making machine while simultaneously removing water. Further dewatering and drying the formed primary fibrous web may occur in one or more steps by mechanical and thermal means until a final dry-solid content of usually about 90 to 99% has been reached.

Each of the embossing rolls used for manufacturing the tissue paper product may be a roll comprising a hard material such as metal, especially steel. Alternatives comprise embossing rolls made of hard rubber or hard plastics materials. The embossing rolls can be a male roll having individual protrusions. Typical heights/depths of the engraved embossing patterns are between 0.4 and 2.0 mm. For the heated embossing, a heatable embossing roll is used.

The machinery used for performing the method may comprise an application system for adhesive consisting of applicator roll, adhesive transfer roll and adhesive bath can be designed as a so-called immersion roll system in which the adhesive transfer roll is immersed into the adhesive bath and transports adhesive by means of surface tension and adhesive forces out of the adhesive bath. By adjusting the gap between the adhesive transfer roll and the applicator or application roll, or by adjusting the relative speed of the transfer roll relative to the applicator roll, the amount of adhesive to be applied can be adjusted. Application rolls may be structured rolls.

A moisture content of a mother reel used to supply plies for manufacturing tissue paper products in accordance with the present disclosure may be in a range of 3% to 15%, optionally 3% to 10%, or optionally 4% to 7%.

An embodiment of the method of manufacturing a tissue paper product, such as toilet paper or household towel, comprising at least three plies, comprises the steps of:
feeding at least three plies, including a first ply, a second ply, and a third ply, with a basis weight in the range of from 13 to 30 g/m², optionally 16 to 28 g/m², or 18 to 24 g/m², respectively;
embossing the first ply on a primary embossing roll with first embossing protrusions with a first height h1 to form first embossments on the first ply and with second embossing protrusions with a second height h2, the first height h1 being larger than the second height h2;
embossing the second ply on a secondary embossing roll with embossing protrusions with a third height h3;
ply-bonding the first ply, the second ply, and the third ply, and optionally further plies, such that the first ply and the second ply are outermost plies and the third ply is an inner ply, using an adhesive, such as a lamination glue, and/or water, and/or mechanical bonding, such as edge embossing;

wherein the inner ply is not embossed, and

wherein at least one of the primary embossing roll and the secondary embossing roll is a heatable roll.

When performing the method, the heatable roll is heated, and the method allows producing a tissue paper product which may have the respective advantages discussed above.

When using adhesive, the adhesive may, e.g., be provided to parts of a side of the inner ply facing the tips of the (e.g., first and/or second) embossments of the first ply, and/or adhesive may, e.g., be provided to tips of (e.g., the first and/or second) embossments of the first ply.

The step of ply-bonding using an adhesive is not limited to applying the adhesive to a particular ply, but constitutes a limitation to where the plies are bonded together by virtue of the ply-bonding. The adhesive can be applied to different plies to achieve ply-bonding of the plies such that the plies are adhere to one another at least at tips of first embossments. That is, the disclosure encompasses embodiments where adhesive is present at tips of first embossments, irrespective of where the adhesive was applied to during the manufacturing process. However, this disclosure also encompasses particular embodiments of the method, involving the application of adhesive of tips of the first embossments (e.g., of the top ply) on the side facing a ply to be ply-bonded therewith.

With “edge embossing”, reference is made to a technique of mechanically bonding plies on the edges. This may be done with wheels with two lines of side embossing and a flat counter-cylinder, and the ply-bonding is effected by exerting mechanical pressure.

A bonding pressure applied to plies to be ply-bonded using water may be set higher than for embodiments in which plies are ply-bonding using an adhesive such as lamination glue.

Base tissue paper may be produced by placing fibres in an oriented or random manner, on one or between two endless continuously rotating wires or felts of a paper making machine while simultaneously removing water. Further dewatering and drying the formed primary fibrous web may occur in one or more steps by mechanical and thermal means until a final dry-solid content of usually about 90 to 99% has been reached.

Each of the embossing rolls used for manufacturing the tissue paper product may be a roll comprising a hard material such as metal, especially steel. Alternatives comprise embossing rolls made of hard rubber or hard plastics materials. The embossing rolls can be a male roll having individual protrusions. Typical heights/depths of the engraved embossing patterns are between 0.4 and 2.0 mm. For the heated embossing, a heatable embossing roll is used.

The machinery used for performing the method may comprise an application system for adhesive consisting of applicator roll, adhesive transfer roll and adhesive bath can be designed as a so-called immersion roll system in which the adhesive transfer roll is immersed into the adhesive bath and transports adhesive by means of surface tension and adhesive forces out of the adhesive bath. By adjusting the gap between the adhesive transfer roll and the applicator or application roll, or by adjusting the relative speed of the transfer roll relative to the applicator roll, the amount of adhesive to be applied can be adjusted. Application rolls may be structured rolls.

A moisture content of a mother reel used to supply plies for manufacturing tissue paper products in accordance with the present disclosure may be in a range of 3% to 15%, optionally 3% to 10%, or optionally 4% to 7%.

According to any one of the above-mentioned embodiments, the at least one heatable roll may be heatable from the inside or outside by a heating means.

The heating means may comprise heat carrying fluid and/or rely on induction and/or infrared heating.

The heatable roll may be heatable to a surface temperature in the range of 80° C. to 170°, optionally 100° C. to 165°, 110° C. to 165°, 120° C. to 160° , or 130° C. to 155°. These temperature ranges may to an increasing degree with narrower ranges promote the manufacturing of a tissue paper product with good shape memory and/or large thickness, high machine direction (MD) and/or cross direction (CD) tensile strength, and good absorption properties.

The references to the temperatures of the heatable embossing roll(s) in this text are references, in particular, to surface temperatures of the embossing roll. These may be measured, for example, using an infrared thermometer. Moreover, the temperature values refer to temperatures in the steady state of the manufacturing apparatus, i.e., not while running and while plies are in contact with the embossing rolls. In particular, the surface temperature of the heatable embossing roll may drop during manufacturing, due to various effects such as heat conduction to the ply in contact with the roll, etc. For example, a surface temperature of 170° C. might be measured in the steady state (when the embossing roll is not in contact with a ply), and this temperature might decrease to a temperature in the range of 100° C. to 130° C. during manufacturing, etc.

The first ply may be moistened with an amount of liquid in the range of 2% to 12% of the basis weight of the first ply, or optionally 4% to 10% of the basis weight of the first ply, prior to being embossed with a heated embossing roll. Analogous statements hold with respect to the second ply. According to some embodiments, the moistening may be effected to the first ply and to the second ply, and both of them may be embossed by a heated embossing roll. The moistening combined with the heated embossing may further promote the shape-memory with respect to the embossments of the resulting tissue paper product.

The moistening may be carried out by adding 0.5 to 3.5 g/m², optionally 1.0 to 3.0 g/m², or 1.5 to 2.5 g/m², or 1.7 to 2.3 g/m², or 1.8 to 2.2 g/m² of liquid to the

Some embodiments of the method comprise the step of applying an adhesive, such as lamination glue, to the first ply and/or the third ply.

According to some embodiments, an embossing load during the embossing the first ply and/or the second ply reaches a range of 1 to 50 kg/cml, or optionally of 5 to 40 kg/cml. The unit “cml” stands for “linear centimeter”. It is thus independent from a machine width. For example, in a machine that is 250 cm wide, an embossing load of 5000 kg will be expressed as 5000/250=20 kg/cml, etc.

According to some embodiments, the third ply is provided as a creped ribbed web with a basis weight in the range of 13 to 30 g/m², optionally 16 to 28 g/m², or 18 to 24 g/m², the creped ribbed web being a web comprising creping lines extending along a first direction and parallel ribs and valleys extending along a second direction.

An angle between the first direction and the second direction may be in a range of 80° to 100° , or even of 85° to 95°. The ribs and valleys may provide an average core roughness Rk in the range of 10 to 300 μm. A number of peaks may be in the range of 4 to 12 per cm as measured in the first direction.

The creped ribbed web may be provided by manufacturing a web using a creping blade provided with a rake edge comprising indentations.

The rake edge may comprise 4 to 12 indentations over a rake edge length.

The indentations on the rake edge may have a depth in a range of 0.1 mm to 1.2 mm.

During manufacturing, a creping blade may be put against a counter cylinder, wherein said creping blade may either be a flat blade or blade with grooves for creating ridges on the tissue paper product. Such a technique may be used in particular on the inner ply during manufacturing.

A conventional dry crepe process may involve creping on a usually 3.0 to 6.5 m diameter drying cylinder, the so-called Yankee cylinder, by means of a crepe doctor blade. Wet creping can be used as well. The creped, finally dry raw tissue paper, the so-called base tissue, is then available for further processing into the paper product for a tissue paper product.

This disclosure further relates to a tissue paper product manufactured according to any of the above-mentioned embodiments of the method in accordance with the present disclosure. Such a tissue paper product may have a good shape memory in terms of the resilience of the embossments after having been wet. The statements about shape memory for the respective embodiments of the tissue paper product are equally applicable here.

This disclosure also relates to a roll of a tissue paper product, such as toilet paper or household towel, made of a spirally wound continuous web of the tissue paper product having a first end and a second end, the web of the tissue paper product being wound such as to define an axially extending inner hole centrally positioned relative to the roll and such that the first end is located on the outer side of the roll and the second end is located at the inner hole, the tissue paper product being the tissue paper product manufactured in accordance with an embodiment of the method in accordance with the present disclosure.

This disclosure also relates to a stack of unfolded sheets or of folded sheets of tissue paper product manufactured in accordance with an embodiment of the method in accordance with the present disclosure.

Additional advantages and features of the present disclosure, that can be realized on their own or in combination with one or several features discussed above, insofar as the features do not contradict each other, will become apparent from the following description of particular embodiments.

### BRIEF DESCRIPTION OF THE DRAWINGS

For a better understanding of the present disclosure and to show how the same may be carried into effect, reference will now be made, by way of example only, to the accompanying drawings, in which:

The description is given with reference to the accompanying drawings, in which:

FIGS. 1 to 3 are sectional views of a first embodiment, a second embodiment, and a third embodiment, of a tissue paper product in accordance with the present disclosure, each of which comprises three plies (wherein plies that have been embossed using a heated embossing roll are illustrated with thicker lines than other pies); and

FIGS. 4 to 12 are sectional views of fourth to twelfth embodiments of a tissue paper product in accordance with the present disclosure, each of which comprises four plies (wherein plies that have been embossed using a heated embossing roll are illustrated with thicker lines than other pies).

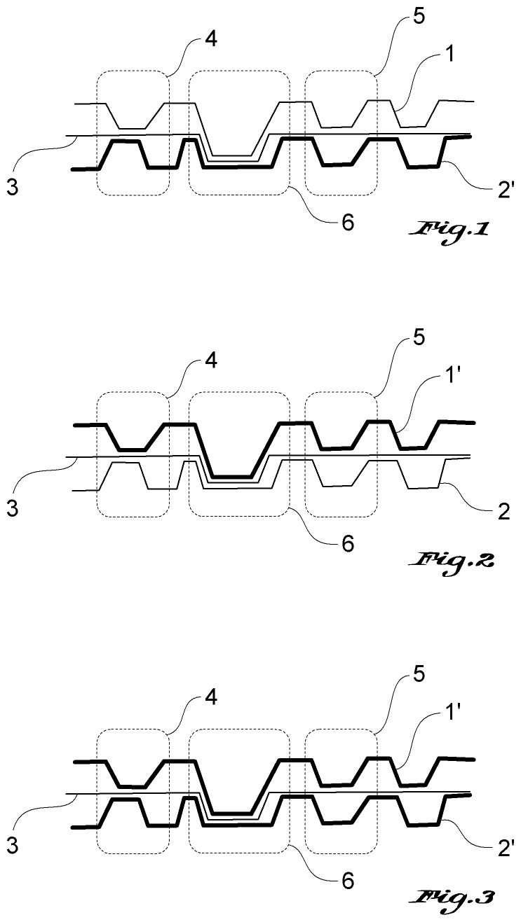

The embodiments of FIGS. 1 to 3 comprise three plies: a top ply 1, a bottom ply 2, and an inner ply 3. A basis weight of the three-ply tissue paper product is in each case in a range of 30 to 150, optionally 30 to 100 g/m², or 35 to 80 g/m², or 40 to 65 g/m².

The top ply 1 of each of the embodiments is embossed with two types of embossments with different heights. The bottom ply 2 is in each case embossed with one type of embossments.

For each of the embodiments of FIGS. 1, 2, and 3, the three plies are ply-bonded, for example, using an adhesive applied to the inner ply 3. However, according to other embodiments, the adhesive may, e.g., be applied to tips of the higher embossments of the top ply 1 and/or to tips of embossments of the bottom ply 2 (in addition to or alterative to the application to the inner ply 3).

In addition, the inner ply 3 of each of the embodiments of FIGS. 1, 2, and 3 has not been pre-embossed. In other words, it is unembossed, at least in the sense of not having been embossed prior to the final ply-bonding having been effected.

Moreover, all three plies of each of the embodiments of FIGS. 1, 2, and 3 are made of Conventional Wet Press (CWP) paper.

At least one of the plies of the tissue paper products of FIGS. 1, 2, and 3 has been embossed using a heated embossing roll. The respective ply or plies is illustrated with a thicker line than other plies, which were not embossed or embossed with a non-heated roll.

In the case of the embodiment of FIG. 1, the bottom ply 2 has been embossed by a heated embossing roll that was heated to a temperature in the range of 80° C. to 170°, optionally 100° C. to 165°, 110° C. to 165°, 120° C. to 160°, or 130° C. to 155°. The top ply 1 of the embodiment of FIG. 1 was embossed with a non-heated embossing roll.

In the case of the embodiment of FIG. 2, the top ply 1 has been embossed by a heated embossing roll that was heated to a temperature in the range of 80° C. to 170°, optionally 100° C. to 165°, 110° C. to 165°, 120° C. to 160°, or 130° C. to 155°. The bottom ply 2 of the embodiment of FIG. 2 was embossed with a non-heated embossing roll.

Both the top ply 1 and the bottom ply 2 of the embodiment of FIG. 3 were embossed by respective heated embossing rolls that were heated to a temperature in the range of 80° C. to 170°, optionally 100° C. to 165°, 110° C. to 165°, 120° C. to 160°, or 130° C. to 155°.

For each of the embodiments of FIGS. 1, 2, and 3, the density of the micro-embossments on the top ply 1 and on the bottom ply 2, respectively, of the embodiments of FIGS. 1, 2, and 3 are provided in a density which lies in a range of 25 to 120 dots/cm². In particular, the first plies 1 in each case comprise first embossments with a first height h1 and second embossments with a second height h2, wherein the first height h1 is larger than the second height h2 (h1>h2). The second embossments are illustrated in the regions 4 and 5, whereas the first embossments (with the larger height) are illustrated in the region 6. The three plies 1, 3, and 2 are ply-bonded at tips of the first embossments (i.e., in the region 6 of the respective figure).

Each of the tissue paper products of FIGS. 1, 2, and 3 has particularly good absorption capacity, a large thickness (as compared to conventional products with a similar strength), and a high (tensile) strength (as compared to conventional products with a similar thickness), both MD tensile strength and CD tensile strength. Specifically, the tissue paper products of FIGS. 1, 2, and 3 have a good wetness shape memory, i.e., the embossments disappear less than in comparable conventional products when the product has been wet.

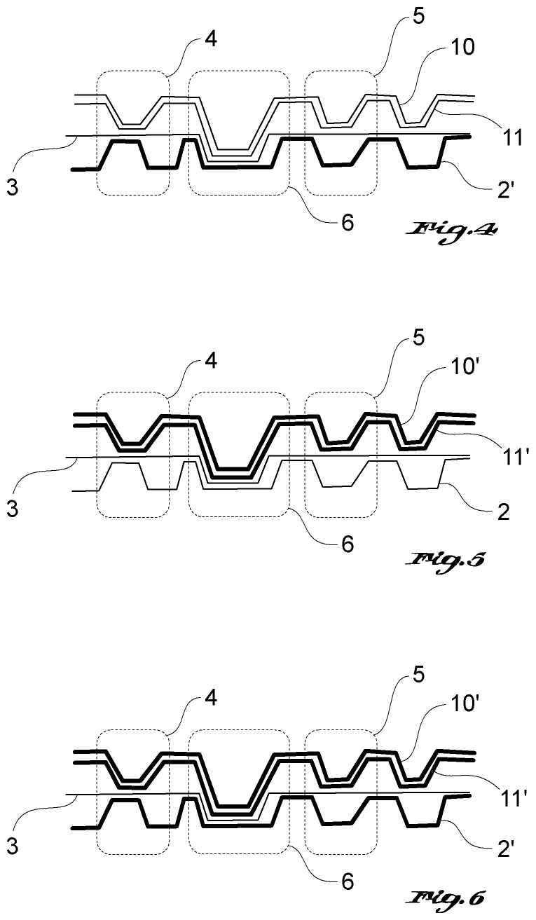

The embodiments of FIGS. 4 to 12 comprise four plies. Again, a ply embossed with a heated embossing roll is in each case illustrated with a thicker line than plies that were not embossed or embossed with a non-heated roll.

In the case of each of the embodiments of FIGS. 4 to 12, a basis weight of a basis weight of the four-ply tissue paper product is in each case in a range of 30 to 150, optionally 30 to 100 g/m², or 35 to 80 g/m², or 40 to 65 g/m². The top ply 1, 10 of each of the embodiments was embossed with two types of embossments with different heights. The bottom ply 2, 20 is in each case embossed with one type of embossments. In each case, the four plies are ply-bonded, for example, using an adhesive applied to the inner ply 3. However, according to other embodiments, the adhesive may, e.g., be applied to tips of the higher embossments of the top ply 1, 10 and/or to tips of embossments of the bottom ply 2 (in addition to or alterative to the application to the inner ply 3).

The inner ply 3 (or inner plies 30, 31) of each of the embodiments of FIGS. 4 to 12 has not been pre-embossed. In other words, it is unembossed at least in the sense of not having been embossed prior to the final ply-bonding having taken place. Moreover, all four plies of each of the embodiments of FIGS. 4 to 12 are made of Conventional Wet Press (CWP) paper.

In the case of the embodiment of FIG. 4, the top ply 10 has been pre-embossed together with another ply 11. Thus, both the top ply 1 and the another ply 11 comprise two types of embossments: first embossments with a first height h1 and second embossments with a second height h2, wherein the first height h1 is larger than the second height h2 (h1>h2). The second embossments are illustrated in the regions 4 and 5, whereas the first embossments (with the larger height) are illustrated in the region 6. The four plies 10, 11, 3, and 2 are ply-bonded at tips of the first embossments (i.e., in the region 6 of FIG. 4).

The top ply 10 and the another ply 11 have been embossed with a non-heated roll. The bottom ply 2 has been embossed by a heated embossing roll that was heated to a temperature in the range of 80° C. to 170°, optionally 100° C. to 165°, 110° C. to 165°, 120° C. to 160°, or 130° C. to 155°.

In the case of the embodiment of FIG. 5, the top ply 10 has been embossed together with another ply 11 by a heated embossing roll that was heated to a temperature in the range of 80° C. to 170°, optionally 100° C. to 165°, 110° C. to 165°, 120° C. to 160°, or 130° C. to 155°. The bottom ply 2 of the embodiment of FIG. 5 was embossed with a non-heated embossing roll. The top ply 1 and the another ply 11 comprise two types of embossments: first embossments with a first height h1 and second embossments with a second height h2, wherein the first height h1 is larger than the second height h2 (h1>h2). The second embossments are illustrated in the regions 4 and 5, whereas the first embossments (with the larger height) are illustrated in the region 6. The four plies 10, 11, 3, and 2 are ply-bonded at tips of the first embossments (i.e., in the region 6 of FIG. 5).

The top ply 10 and another ply 11 of the embodiment of FIG. 6 were embossed together with a heated embossing rolls that were heated to a temperature in the range of 80° C. to 170°, optionally 100° C. to 165°, 110° C. to 165°, 120° C. to 160°, or 130° C. to 155°. In addition, also the bottom ply 2 of the embodiment of FIG. 6 was embossed by a heated embossing roll that was heated to a temperature in the range of 80° C. to 170° , optionally 100° C. to 165°, 110° C. to 165°, 120° C. to 160°, or 130° C. to 155°. The top ply 10 and the another ply 11 comprise first embossments with a first height h1 and second embossments with a second height h2, wherein the first height h1 is larger than the second height h2 (h1>h2). The second embossments are illustrated in the regions 4 and 5, whereas the first embossments (with the larger height) are illustrated in the region 6. The four plies 10, 11, 3, and 2 are ply-bonded at tips of the first embossments (i.e., in the region 6 of FIG. 6).

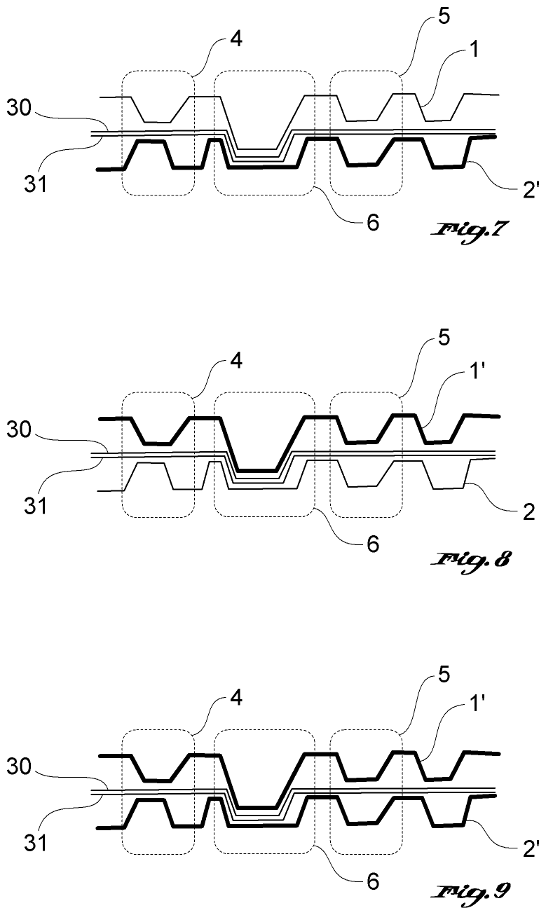

Also the basis weight of the embodiments of FIGS. 7, 8, and 9, is in each case in a range of 30 to 150, optionally 30 to 100 g/m², or 35 to 80 g/m², or 40 to 65 g/m². The embodiments of FIGS. 7, 8, and 9 differ from those of FIGS. 4, 5, and 6, for example, in that they all have two inner plies 30 and 31. These have in each case been bonded to each other before the final ply-bonding of all four plies of the respective tissue paper product. In other words, the inner plies 30 and 31 are unembossed at least in the sense of not having been embossed prior to the final ply-bonding having taken place.

All four plies of each of the embodiments of FIGS. 7, 8, and 9 are made of Conventional Wet Press (CWP) paper.

The top ply 1 of each of the embodiments of FIGS. 7, 8, and 9 is embossed with two types of embossments with different heights: first embossments with a first height h1 and second embossments with a second height h2, wherein the first height h1 is larger than the second height h2 (h1>h2). The second embossments are illustrated in the regions 4 and 5, whereas the first embossments (with the larger height) are illustrated in the region 6. The four plies 1, 30, 31, and 2 are ply-bonded at tips of the first embossments (i.e., in the region 6 of FIGS. 7, 8, and 9, respectively). The bottom ply 2 is in each case embossed with one type of embossments. In each case, the three plies are ply-bonded, for example, using an adhesive applied to the side of the ply 31 facing the bottom ply 2, 2″. However, according to other embodiments, the adhesive may, e.g., be applied to tips of the higher embossments of the top ply 1, 1″ and/or to tips of embossments of the bottom ply 2, 2″, to the other side of the inner ply 31 and/or to the inner ply 30, etc.

In the case of the embodiment of FIG. 7, the bottom ply 2 has been embossed by a heated embossing roll that was heated to a temperature in the range of 80° C. to 170°, optionally 100° C. to 165°, 110° C. to 165°, 120° C. to 160°, or 130° C. to 155°. The top ply 1 of the embodiment of FIG. 7 was embossed with a non-heated embossing roll.

In the case of the embodiment of FIG. 8, the top ply 1 has been embossed by a heated embossing roll that was heated to a temperature in the range of 80° C. to 170°, optionally 100° C. to 165°, 110° C. to 165°, 120° C. to 160°, or 130° C. to 155°. The bottom ply 2 of the embodiment of FIG. 8 was embossed with a non-heated embossing roll.

Both the top ply 1 and the bottom ply 2 of the embodiment of FIG. 9 were embossed by respective heated embossing rolls that were heated to a temperature in the range of 80° C. to 170°, optionally 100° C. to 160°, 110° C. to 165°, 120° C. to 160°, or 130° C. to 155°.

Each of the tissue paper products of FIGS. 7, 8, and 9 has particularly good absorption properties, a large thickness (as compared to conventional products with a similar strength), and a high (tensile) strength (as compared to conventional products with a similar thickness). Specifically, the tissue paper products of FIGS. 7, 8, and 9 have a good wetness shape memory, i.e., the embossments disappear less than in comparable conventional products when the product has been wet.

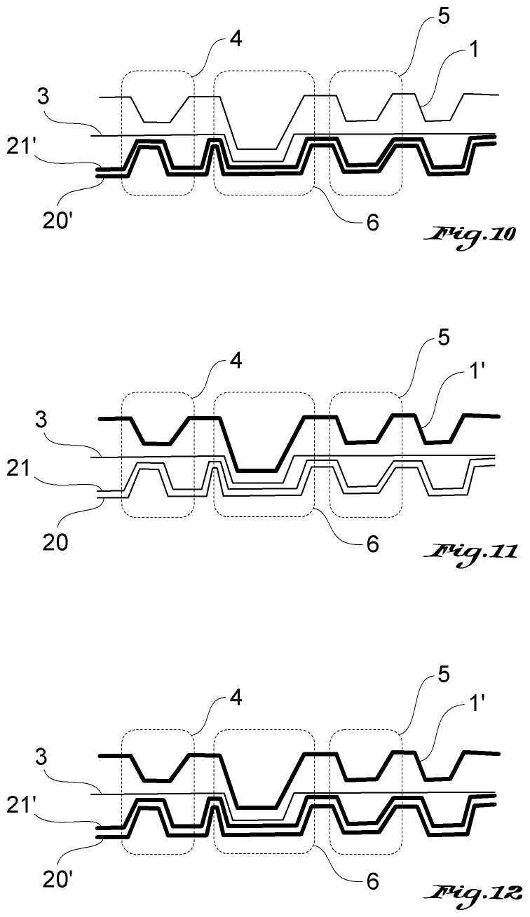

The embodiments of FIGS. 10, 11, and 12 differ from those of FIGS. 7, 8, and 9, for example, in that they all have one inner ply 3, and a bottom ply 20 that has been embossed together with another ply 21. Also the basis weight of the embodiments of FIGS. 10, 11, and 12 is in each case in a range of 30 to 150 g/m². The inner ply 3 is in each case unembossed at least in the sense of not having been embossed prior to the final ply-bonding having taken place.

All four plies of each of the embodiments of FIGS. 10, 11, and 12 are made of Conventional Wet Press (CWP) paper.

The top ply 1, 10 of each of the embodiments of FIGS. 10, 11, and 12 is embossed with two types of embossments with different heights. The bottom ply 2 is in each case embossed with one type of embossments. In each case, the four plies are ply-bonded, for example, using an adhesive applied to the side of the inner ply 3 facing the ply 21. However, according to other embodiments, the adhesive may, e.g., be applied to tips of the higher embossments of the top ply 1 and/or to tips of embossments of the bottom ply 20, 20′, 21, 2′, etc. (in addition to or alterative to the application to the inner ply 3).

In the case of the embodiment of FIG. 10, the bottom ply 20 and an another ply 21 have been embossed together by a heated embossing roll that was heated to a temperature in the range of 80° C. to 170°, optionally 100° C. to 165°, 110° C. to 165°, 120° C. to 160°, or 130° C. to 155°. The top ply 1 of the embodiment of FIG. 10 was embossed with a non-heated embossing roll.

In the case of the embodiment of FIG. 11, the top ply 1 has been embossed by a heated embossing roll that was heated to a temperature in the range of 80° C. to 170°, optionally 100° C. to 165°, 110° C. to 165°, 120° C. to 160°, or 130° C. to 155°. The bottom ply 20 and an another ply 21 of the embodiment of FIG. 11 have been embossed by a non-heated embossing roll.

Both the top ply 1 as well as bottom ply 20 and (together with the bottom ply 20) the another ply 21 of the embodiment of FIG. 12 have been embossed by respective heated embossing rolls that were heated to a temperature in the range of 80° C. to 170°, optionally 100° C. to 165°, 110° C. to 165°, 120° C. to 160°, or 130° C. to 155°.

Each of the tissue paper products of FIGS. 10, 11, and 12 has particularly good absorption properties, a large thickness (as compared to conventional products with a similar strength), and a high (tensile) strength (as compared to conventional products with a similar thickness). Specifically, the tissue paper products of FIGS. 10, 11, and 12 have a good wetness shape memory, i.e., the embossments disappear less than in comparable conventional products when the product has been wet.

For each of the embodiments of FIGS. 4 to 12, the density of the micro-embossments on the outermost plies are provided in a density which lies in a range of 25 to 120 dots/cm².

Moreover, each of the tissue paper products of FIGS. 4 to 12 has particularly good absorption properties, a large thickness (as compared to conventional products with a similar strength), and a high (tensile) strength (as compared to conventional products with a similar thickness). Specifically, the tissue paper products of FIGS. 4 to 12 a good wetness shape memory, i.e., the embossments disappear less than in comparable conventional products when the product has been wet.

### EXPERIMENTAL RESULTS

In the following, experimental examples of embodiments (examples) in accordance with the present disclosure will be compared with conventional tissue paper products.

### EXAMPLE SERIES 1

Tissue paper product with three plies made of Conventional Wet Press (CWP) paper in accordance with the present disclosure were compared to conventional tissue paper products comprising three plies made of Conventional Wet Press (CWP) paper. For both products, a total grammage of the tissue paper product was around 53.5 g/m².

The top ply was double-height embossed, wherein a part comprising micro-embossments was provided with the micro- embossments at a density of 50 dots/cm². The double-height embossments covered about 3.7% of the surface area of the top ply. The middle play was flat (i.e., unembossed prior to final ply-bonding, that is, not pre-embossed). The bottom ply was provided with micro-embossments at a density of 43 dots/cm².

In each case, a roll of the tissue paper product with a diameter of 120 mm was produced. The roll length was adapted according to thickness variations so that the roll firmness of different products was about the same. The top ply was embossed with a double height embossing design, the inner ply remained flat (no pre-embossing on the inner ply). The bottom ply was embossed with a micro-embossing design.

For the tissue paper products in accordance with the present embodiments, a micro-embossing design with a density of 43 d/cm² (d/cm² stands for dots per square centimeter) was used. For the reference products, a two micro-embossing designs with densities of 51 d/cm² and 43 d/cm² were used. No water was added to the inner ply. The manufacturing speed for the products was chosen both for examples in accordance with the present disclosure as well as reference examples to be at 100 m/min.

### Results

The tissue paper products produced using a heated embossing roll have a larger thickness even at lower embossing load as compared to the reference examples. This is illustrated in the following graph:

The products in accordance with the present disclosure are illustrated in the graph with triangles. The comparative products are illustrated with circular and diamond shapes. The impact of heating the embossing roll on the CD tensile is shown in the following graph. It shows that the CD tensile remains in the same range (216-222 N/m), whereas the thickness increases by up to 15% (from 0.61 mm to 0.70 mm). The CD tensile appears to drop only for a higher thickness increase:

The impact of heating the embossing roll on the MD tensile is shown in the following graph (“MDT” on the y-axis stands for main direction tensile strength). The graph shows that MD tensile increases with heating, in comparison to the reference products, whereas the thickness increases by up to 15% (from 0.61 mm to 0.70 mm):

The impact of heating the embossing roll on the absorption (in g/g) is shown in the next graph (“CDT” on the y-axis stands for cross direction tensile strength). It shows that the absorption increases with heating. The higher the thickness, the higher the absorption:

### EXAMPLE SERIES 2

Tissue paper products comprising three plies of CWP and a total grammage of around 50 g/m² were compared. A roll of diameter 120 mm was produced. The roll length was adapted according to thickness variations so that the roll firmness of different products was about the same. The top ply was embossed with a double height embossing design, wherein a part comprising micro-embossments was provided with the micro-embossments at a density of 50 dots/cm². The double-height embossments covered about 4.5% of the surface area of the top ply. The inner ply remained flat. The bottom ply was embossed with a micro-embossing design having 50 d/cm². Trials were carried out with reference products (no addition of water and no heating of the micro-embossing roll) and products in accordance with the present disclosure (addition of 1.0 g/m² of water on the bottom ply with a Weko unit and micro-embossing of this ply with a heated roller). Trials were carried out at a processing speed of 650 m/min.

### Results

The following graphs show the variation of CD and MD tensile strength when the thickness of the tissue paper product is increased. Surprisingly, when using the heated embossing roll to produce the tissue paper product, when thickness increases by 16% vs. the reference product, the CD tensile strength is still higher than the one of the reference product (and when thickness is increased by 20% the MD tensile is still higher than the reference value):

### Comparative Examples Using Products With Two Plies

Comparisons were also made between bathroom tissue products with two plies that were either made with or without using a heated embossing roll, and with a random nested structure (nesting of embossments, without, however, synchronizing the rolls to create a systematic nested structure), to identify whether the use of a heated embossing roll would allow increasing the thickness of tissue paper products.

### Results

A decrease of the tensile strength was perceived, as soon as the thickness increase exceeded about 5%. The example below shows results from trials performed with a 2-ply bathroom towel with a grammage of 33 g/m². The top ply was embossed with a double height embossing design, the bottom ply was embossed with a micro-embossing design having 43d/cm². For the reference trial, this roll was not heated, whereas for the trials with a heated roll, the sheet was pre-moistened with 1.0 g/m², and then embossed with the heated micro-embossing roller.

From these findings, it may be concluded that the desirable properties relating to increased thickness, high tensile strength, and good absorption, manifest themselves mostly in tissue paper products comprising at least three plies and having an unembossed inner ply.

### EXAMPLE SERIES 3

Comparisons were made between tissue paper products produced with a bottom ply produced either using a heated embossing roll or a non-heated roll, as well as either comprising a flat inner ply (unembossed prior to final ply-bonding) made of Conventional Wet Press (CWP) paper (and referred to as “Standard” in the following) or a creped ribbed inner ply, i.e., a ply produced using a creping blade provided with a rake edge comprising indentations. Those inner plies were combined with two outer plies of the same quality and are in the following referred to as “Trio”.

The exemplary products as well as the reference products were made with three plies of Conventional Wet Press (CWP) paper with a total grammage of around 53.5 g/m².

The top ply was embossed with a density of 50 dots/cm² and with double-height embossments covering about 3.7% of the surface area of the top ply. The middle play was provided with a creped ribbed structure. The number of peaks in a cross direction associated with ribs and valleys amounted to about 9 peaks per cm, and the core roughness (Rk value) in the cross direction was 70.7 μm. The bottom ply was heat-embossed with an embossment density of 43 dots/cm².

Core Roughness Rk, as referred to here, is defined according to ISO 13565-1 and ISO 13565-2. The roughness profile as per ISO 13565-1 is generated by a special filtering technique minimizing profile distortions due to deep valleys in plateau profiles. A straight line divides the Abbott-Firestone curve (See FIG. 2) into three areas from which the parameters are then computed as per ISO 13565-2. Core roughness depth Rk is the depth of the roughness core profile. In other words, it is the core height of the profile along the Y-axis of the Abbott-Firestone curve generated by placing a 40% line on the curve at the minimum slope point and extending the lines to the 0% and the 100% points.

A roll with a diameter of 120 mm was produced, and the roll length have been adapted according to thickness variations so that the roll firmness remained the same.

Two different plies were used for the inner ply: a standard paper (denoted as the “Reference” in the following) and a paper produced according to a creping process using a creping blade with a rake edge provided with indentations.

Moreover, some products were made using non-pre-moistened and non-heated embossing rolls for the bottom ply, and some products were made using pre-moistening and embossing with a heated roll for bottom ply. The thicknesses of the products were measured.

### Results

It was found that the creped ribbed ply allows further increasing the thickness of the products (of both those with an inner ply produced without pre-moistening and without using a non-heated embossing roll, as well as of those with an inner ply produced with pre-moistening and embossing with a heated embossing roll).

| | Heating + | |
|---|---|---|
| | pre- | Thickness |
| | moistening | (1 sheet) |
| Trio | off | 0.61 |
| Reference | | |
| Trio | | |
| Trio | off | 0.63 |
| Creped ribbed ply | | |
| Trio | | |
| Trio | on | 0.71 |
| Reference | | |
| Trio | | |
| Trio | on | 0.73 |
| Creped ribbed ply | | |
| Trio | | |

### EXAMPLE SERIES 4

Another study was performed on the basis of tissue paper products with three plies made of Conventional Wet Press (CWP) paper and a total grammage of around 53.5 g/m². A roll with a diameter of 120 mm was produced, and the roll length was adapted according to thickness variations so that the roll firmness remained the same.

Comparisons were made between products obtained using the following alternative manufacturing conditions:
Double-height embossing of top and inner ply: The top and the inner ply were embossed together with a double height embossing design. Micro-embossments were provided at a density of 50 dots/cm² and the double-height embossments covered about 3.7% of the surface area. As an alternative, products were made with a flat inner ply (an inner ply that was not pre-embossed). The bottom ply was embossed with a micro-embossing design (density 43 d/cm²), and the three plies were bonded together with a random nested structure; and
Double-height embossing of top ply, flat inner ply: The top ply was embossed with a double height embossing design, the inner ply remained flat. The bottom ply was embossed with a micro-embossing design (density 43 d/cm²).

For each of the two processes, the bottom embossing was either performed with a non-heated roll (referred to as the “reference” condition) or with a heated roll, wherein the bottom ply was pre-moistened prior to the heat-embossing. Several trials were run to produce the various products, using different embossing loads for the bottom ply (the top plies were always embossed using the same load). All of the products were manufactured at a processing speed of 200 m/min.

Results

The following graph show the obtained product thickness being in function of the embossing load:

The graph compares the thicknesses of products with a flat inner ply produced without a heated embossing roll with products with a flat inner ply and manufactured using heat-embossing, as well as products with a random nested structure produced using a non-heated embossing roll with products with a random nested structure produced manufactured using a heated embossing roll in function of the embossing load. The thickness of products with a flat inner ply, when manufactured using the same embossing load, is substantively increased by using a heated embossing roll. Similarly, the thickness of products with a random nested structure is significantly increased with respect to the reference product manufactured with the same embossing load. The products with a random nested structure manufactured with a heated embossing roll achieve similar thicknesses at the same embossing load as products with a flat inner ply but manufactured without heat-embossing. Thus, the benefit of heat-embossing may be particularly high for manufacturing products with a flat inner ply.

The next graph illustrates results regarding the tensile strength (Cross Direction (CD) tensile strength):

The products with a random nested structure and manufactured using heat-embossing performed similarly as products with a flat inner ply that were manufactured without heat-embossing: roughly the same CD tensile strength was achieved for equal thickness, and for the higher thickness reached with a flat inner ply and using heated embossing during manufacturing, the curve slope is equivalent or slightly higher for products with a flat inner ply as opposed to those with a random nested structure. The products with a flat inner ply and manufactured using a heated embossing roll performed better than those also manufactured using a heated embossing roll, but having a random nested structure (i.e., the embossments of the inner ply are nested randomly in the embossments of one of the outer plies): the CD tensile strength was higher for same thickness, with a gain of about 20%), and the CD tensile strength of the products with a flat inner ply and manufactured using a heated embossing roll was higher than the one of the products manufactured using a heated embossing roll, but having a random nested structure, when comparing products with equal thicknesses.

It will be apparent to those skilled in the art that various modifications and variations can be made in the disclosed devices and systems without departing from the scope of the disclosure. Other aspects of the disclosure will be apparent to those skilled in the art from consideration of the specification and practice of the features disclosed herein. It is intended that the specification and examples be considered as exemplary only. Many additional variations and modifications are possible and are understood to fall within the framework of the disclosure.

1. A tissue paper product, such as toilet paper or household towel,
wherein the tissue paper product comprises at least three plies including a to p ply, a bottom ply, and an inner ply located between the top ply and the bottom ply, the top ply and the bottom ply being outermost plies of the tissue paper product, a basis weight of the tissue paper product being in a range of 30 to 150, optionally 30 to 100 g/m², or 35 to 80 g/m², or 40 to 65 g/m²,
wherein the top ply has been embossed and comprises at least two types of embossments including first embossments with a first height and second embossments with a second height, the first height being larger than the second height,
wherein the inner ply has not been embossed, wherein the bottom ply has been embossed,
the top ply, the inner ply, and the bottom ply are ply-bonded with an adhesive, such as a lamination glue, and/or water and/or mechanical bonding, such as edge embossing,
wherein at least one of the top ply and the bottom ply has been embossed by a heated embossing roll.

2. The tissue paper product of claim 1, wherein at least one of the plies of the tissue paper product, optionally all of the plies of the tissue paper product, are made of Conventional Wet Press (CWP) paper.

3. The tissue paper product of claim 1, wherein the tissue paper product comprises a number of plies between three and six.

4. The tissue paper product of claim 1, wherein the tissue paper product comprises exactly three plies.

5. The tissue paper product of claim 1, wherein the tissue paper product comprises exactly four plies comprising the top ply, the bottom ply, the inner ply, and an another ply, wherein optionally the another ply and the top ply are embossed together or the another ply and the bottom ply are embossed together, or the another ply and the inner ply are combined with the top ply and ply-bonded with the bottom ply at tips of the first embossments with an adhesive, such as lamination glue.

6. The tissue paper product of claim 1, wherein the tissue paper product comprises exactly five or six plies.

7. The tissue paper product of claim 1, wherein the inner ply optionally, is only partially embossed at locations where it is ply-bonded with the top ply and the bottom ply.

8. The tissue paper product of claim 1, wherein the top ply includes exactly two types of embossments, being decorative embossments with an embossing height in a range of 0.2 mm to 2.0 mm, optionally 0.8 mm to 1.4 mm, and micro-embossments with an embossing height in a range of 0.1 mm to 1.2 mm, wherein
wherein the decorative embossments cover between 1% and 20% of a total surface of the top ply, optionally between 2% and 10%, or between 3% and 6%,
wherein the tissue paper product comprises at least one region in which a density of the micro-embossments is, in the area of the top ply without the decorative embossments, in a range of 25 to 120 dots/cm²,
optionally 40 to 100 dots/cm², or 50 to 80 dots/cm², and wherein, optionally, the bottom ply includes exactly one or two types of embossments and wherein the density of the total number of embossments of the bottom ply is in the range of from 25 to 120 dots/cm²,
optionally 40 to 100 dots/cm², or 50 to 80 dots/cm².

9. The tissue paper product of claim 1, wherein the inner ply and the top ply are ply-bonded with the bottom ply by the adhesive applied only in an area comprising, optionally consisting of, the tips of the first embossments, optionally at least 95%, 98%, or even at least at 99% of the tips of the first embossments.

10. The tissue paper product of claim 1, wherein the inner ply is a creped ply having a basis weight in the range of 13 to 30 g/m², optionally 16 to 28 g/m², or 18 to 24 g/m²,
wherein the creped ply comprises creping lines extending along a first direction and parallel ribs and valleys extending along a second direction,
an angle between the first direction and the second direction is in a range of 80° to 100°,
the ribs and valleys provide an average core roughness Rk in the range of 10 to 300 μm, and
a number of peaks is in the range of 4 to 12 per cm as measured in the first direction.

11. A roll of tissue paper product made of a spirally wound continuous web of the tissue paper product of claim 1, the tissue paper product having a first end and a second end, the web of tissue paper product being wound such as to define an axially extending inner hole centrally positioned relative to the roll and such that the first end is located on the outer side of the roll and the second end is located at the inner hole.

12. The roll of tissue paper product of claim 11, wherein a diameter of the roll is in a range of from 85 to 200 mm.

13. A stack of unfolded sheets or of folded sheets, optionally of interfolded sheets, made of tissue paper product of claim 1.

14. A method of manufacturing a tissue paper product, such as toilet paper or household towel, comprising at least three plies, comprising the steps of:
feeding at least three plies, including a first ply, a second ply, and a third ply, with a basis weight in the range of from 13 to 30 g/m², optionally 16 to 28 g/m², or 18 to 24 g/m², respectively;
embossing the first ply on a first embossing roll with embossing protrusions with a first height h1 to form first embossments on the first ply,
embossing the first ply on a second embossing roll with second embossing protrusions with a second height h2, the first height h1 being larger than the second height h2, wherein the embossing on the second embossing roll is carried out before or after the embossing on the first embossing roll;
embossing the second ply on a third embossing roll with embossing protrusions with a third height h3;
ply-bonding the first ply, the second ply, and the third ply, and optionally further plies, such that the first ply and the second ply are outermost plies and the third ply is an inner ply, using an adhesive, such as a lamination glue, and/or water, and/or mechanical bonding, such as edge embossing;
wherein the inner ply is not embossed, and
wherein at least one of the first embossing roll, the second embossing roll, and the third embossing roll is a heatable roll.

15. A method of manufacturing a tissue paper product, such as toilet paper or household towel, comprising at least three plies, comprising the steps of:
feeding at least three plies, including a first ply, a second ply, and a third ply, with a basis weight in the range of from 13 to 30 g/m², optionally 16 to 28 g/m², or 18 to 24 g/m², respectively;
embossing the first ply on a primary embossing roll with first embossing protrusions with a first height h1 to form first embossments on the first ply and with second embossing protrusions with a second height h2, the first height h1 being larger than the second height h2;
embossing the second ply on a secondary embossing roll with embossing protrusions with a third height h3;
ply-bonding the first ply, the second ply, and the third ply, and optionally further plies, such that the first ply and the second ply are outermost plies and the third ply is an inner ply, using an adhesive, such as a lamination glue, and/or water, and/or mechanical bonding, such as edge embossing;
wherein the inner ply is not embossed, and
wherein at least one of the primary embossing roll and the secondary embossing roll is a heatable roll.

16. The method of manufacturing a tissue paper product of claim 14, wherein the at least one heatable roll is heated from the inside or outside by a heating means, the heating means optionally comprising heat carrying fluid and/or relying on induction and/or infrared heating, to a surface temperature in the range of 80° C. to 170° , optionally 100° C. to 165°, 110° C. to 165°, 120° C. to 160°, or 130° C. to 155°.

17. The method of manufacturing a tissue paper product of claim 14, wherein the first ply or the second ply is moistened with an amount of liquid in the range of 2% to 12% of the basis weight of the first ply, or optionally 4% to 10% of the basis weight of the first ply, prior to being embossed with a heated embossing roll.

18. The method of manufacturing a tissue paper product of claim 1, comprising the step of applying an adhesive, such as lamination glue, to the first ply and/or the third ply.

19. The method of manufacturing a tissue paper product of claim 14, wherein an embossing load during the embossing the first ply and/or the second ply reaches a range of from to 1 to 50 kg/cml, or optionally 5 to 40 kg/cml.

20. The method of manufacturing a tissue paper product of claim 14, wherein the third ply is provided as a creped ribbed web with a basis weight in the range of 13 to 30 g/m², optionally 16 to 28 g/m², or 18 to 24 g/m², the creped ribbed web being a web comprising creping lines extending along a first direction and parallel ribs and valleys extending along a second direct ion,
wherein an angle between the first direction and the second direction is in a range of 80° to 100°, the ribs and valleys provide an average core roughness Rk in the range of 10 to 300 μm, and a number of peaks is in the range of 4 to 12 per cm as measured in the first direction.

21. The method of manufacturing a tissue paper product of claim 20, wherein the creped ribbed web is provided by manufacturing a web using a creping blade provided with a rake edge comprising indentations,
the rake edge optionally comprising 4 to 12 indentations over a rake edge length and/or the indentations optionally having a depth in a range of 0.1 mm to 1.2 mm.

22. A tissue paper product manufactured according to the method of claim 14.

23. A roll of a tissue paper product, such as toilet paper or household towel, made of a spirally wound continuous web of the tissue paper product having a first end and a second end, the web of the tissue paper product being wound such as to define an axially extending inner hole centrally positioned relative to the roll and such that the first end is located on the outer side of the roll and the second end is located at the inner hole, the tissue paper product being the tissue paper product of claim 24.

24. A stack of unfolded sheets or of folded sheets, optionally of interfolded sheets, made of tissue paper product of claim 22.
